(19) United States
(12) Patent Application Publication
(10) Pub. No.: US 2015/0332855 A1
(43) Pub. Date: Nov. 19, 2015

(54) MULTILAYER FILM

(71) Applicant: DAIKIN INDUSTRIES, LTD., Osaka-Shi, Osaka (JP)

(72) Inventors: Meiten KOH, Settsu-shi, Osaka (JP); Nobuyuki KOMATSU, Settsu-shi, Osaka (JP); Takeshi HAZAMA, Settsu-shi, Osaka (JP); Hisako NAKAMURA, Settsu-shi, Osaka (JP); Kouji YOKOTANI, Settsu-shi, Osaka (JP); Miharu OTA, Settsu-shi, Osaka (JP); Fumiko SHIGENAI, Settsu-shi, Osaka (JP); Mayuko TATEMICHI, Settsu-shi, Osaka (JP); Masakazu KINOSHITA, Settsu-shi, Osaka (JP)

(73) Assignee: DAIKIN INDUSTRIES, LTD., Osaka-shi, Osaka (JP)

(21) Appl. No.: 14/432,514

(22) PCT Filed: Nov. 14, 2013
(86) PCT No.: PCT/JP2013/080808

§ 371 Date: Mar. 31, 2015

(30) Foreign Application Priority Data
Nov. 20, 2012 (JP) 2012-254597

(51) Int. Cl. H01G 4/30; H01G 4/08; H01G 4/01

(52) U.S. Cl. CPC H01G 4/306; H01G 4/01; H01G 4/08

(57) ABSTRACT

The present invention aims to provide a multilayer film which can increase the capacitance. The present invention relates to a multilayer film including a first electrode layer, a resin substrate, a second electrode layer, and a dielectric layer stacked in the order set forth. The dielectric layer includes a vinylidene fluoride/tetrafluoroethylene copolymer (A). The copolymer (A) satisfies a mole ratio (vinylidene fluoride)/(tetrafluoroethylene) of 97/3 to 60/40.

### TECHNICAL FIELD

The present invention relates to a multilayer film.

### BACKGROUND ART

Recent miniaturization of elements such as transistors and diodes has led to a demand for miniaturization of capacitors such as film capacitors. Still, it is not easy to miniaturize a capacitor without a decrease in its capacitance because the capacitance of a capacitor is proportional to the area of the electrode.

A film capacitor can be miniaturized by, for example, a method of increasing the dielectric constant of a dielectric substance or a method of thinning a dielectric substance.

For example, Patent Literature 1 discloses a method of producing a rolled capacitor comprising applying a liquid such as a molten solution or a solution of an organic dielectric substance onto a conductive thin film to form a dielectric ultra-thin film, and rolling the resulting laminate of two or more films such that the conductive thin film and the dielectric ultra-thin film are stacked alternately.

Further, Patent Literature 2 discloses a multilayer film comprising a substrate that is a flexible film consisting of an organic polymer composition; an electrode layer consisting of a metal thin film stacked on one or both surfaces of the substrate; and a dielectric layer consisting of a high dielectric thin film stacked on one or both surfaces of the electrode layer(s).

### CITATION LIST

### Patent Literature

Patent Literature 1: JP S56-21310 A
Patent Literature 2: JP S59-135714 A

### SUMMARY OF INVENTION

### Technical Problem

The present invention aims to provide a multilayer film which can increase the capacitance.

### Solution to Problem

The present invention relates to a multilayer film comprising a first electrode layer, a resin substrate, a second electrode layer, and a dielectric layer stacked in the order set forth, the dielectric layer comprising a vinylidene fluoride/tetrafluoroethylene copolymer (A), and the copolymer (A) satisfying a mole ratio (vinylidene fluoride)/(tetrafluoroethylene) of 97/3 to 60/40.

The copolymer (A) preferably satisfies a mole ratio (vinylidene fluoride)/(tetrafluoroethylene) of 95/5 to 75/25.

The dielectric layer preferably has a thickness of 0.1 to 12 μm.

The resin substrate is preferably a film of at least one resin selected from the group consisting of polyolefins, polyesters, polycarbonates, polyimides, polysulfones, and polyphenylsulfones.

The resin substrate preferably has a thickness of 0.5 to 15.0 μm.

The present invention also relates to a film capacitor comprising the aforementioned multilayer film.

### Advantageous Effects of Invention

Since the multilayer film of the present invention has the aforementioned structure, it can increase the capacitance.

### BRIEF DESCRIPTION OF THE DRAWINGS

FIG. 1 is a schematic cross-sectional view showing one structure of the multilayer film of the present invention.

FIG. 2 is a schematic cross-sectional view showing another structure of the multilayer film of the present invention.

### DESCRIPTION OF EMBODIMENTS

The multilayer film of the present invention comprises a first electrode layer, a resin substrate, a second electrode layer, and a dielectric layer stacked in the order set forth. The dielectric layer comprises a copolymer (A) of vinylidene fluoride (VdF) and tetrafluoroethylene (TFE). The copolymer (A) satisfies a mole ratio VdF/TFE of 97 to 60/3 to 40.

Since the multilayer film of the present invention has the above multilayer structure and the dielectric layer comprises the specific VdF/TFE copolymer (A), the dielectric layer can have a high dielectric constant and the multilayer film can increase the capacitance.

The present invention is described in detail below.

The multilayer film of the present invention comprises the first electrode layer, the resin substrate, the second electrode layer, and the dielectric layer stacked in the order set forth.

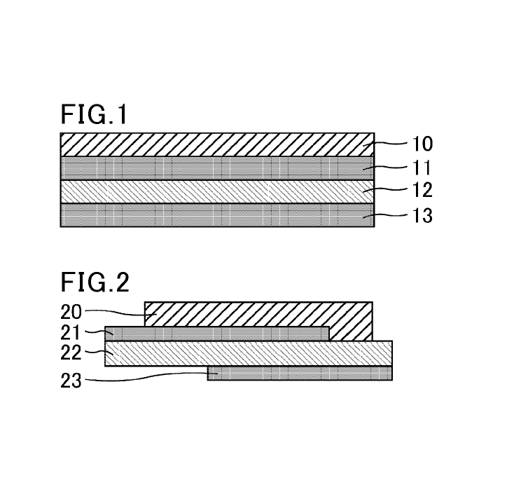

FIGS. 1 and 2 are schematic cross-sectional views each showing the structure of the multilayer film of the present invention.

As shown in FIG. 1, the multilayer film of the present invention comprises a first electrode layer 13, a resin substrate 12, a second electrode layer 11, and a dielectric layer 10 stacked in the order set forth.

As shown in FIG. 2, the multilayer film of the present invention may comprise a first electrode layer 23, a resin substrate 22, a second electrode layer 21, and a dielectric layer 20 stacked such that the layers do not completely overlap.

The first electrode layer and the second electrode layer may be formed of any material, and usually formed of a conductive metal such as aluminum, zinc, gold, platinum, or copper. The first electrode layer and the second electrode layer each may be a metal foil or a metal vapor deposition film.

In the present invention, one of a metal foil and a metal vapor deposition film may be used or both of these may be used in combination. A metal vapor deposition film is usually preferred because it allows for thinning of the electrode layer, resulting in an increase in the capacitance per volume, it is excellent in adhesion with the dielectric substance, and it causes less variation in the thickness.

The metal vapor deposition film is not limited to those having a single layer. If necessary, the metal vapor deposition film may have a multilayer structure prepared by a method of forming not only an aluminum layer for imparting moisture resistance but also an aluminum oxide layer which is a semiconductor, thereby constituting an electrode layer (e.g., JP H2-250306). The metal vapor deposition film may have any thickness, and it is preferably 100 to 2000 angstroms, and more preferably 200 to 1000 angstroms. A metal vapor deposition film having a thickness within this range is suitable for achieving the effects of improving both the electrical conductivity and the voltage resistance of the multilayer film.

A metal vapor deposition film to be used as an electrode layer may be formed by any method. Examples of the production method include vacuum deposition, plasma CVD, spattering, and ion plating. In order to achieve good productivity, vacuum deposition, a plasma CVD, or spattering is preferred.

Also, a metal foil to be used as the first electrode layer and/or the second electrode layer may have any thickness. The thickness is usually 0.1 to 100 μm, preferably 1 to 50 μm, and more preferably 3 to 15 μm.

If the electrode layer is formed on the resin substrate, the surface of the resin substrate may be subjected to an adhesiveness-improving treatment, such as corona treatment or plasma treatment, in advance.

The multilayer film of the present invention comprises the resin substrate.

Since the multilayer film of the present invention comprises the dielectric layer including the copolymer (A), it has a high capacitance. If the copolymer (A) alone is used, however, the resulting multilayer film has an insufficient strength. Since the multilayer film of the present invention comprises a combination of the resin substrate and the dielectric layer, it can increase the capacitance and is excellent in strength.

The resin substrate may be a film of any of polyolefins (e.g., polypropylene, polyethylene), polycarbonates, polyethylene terephthalate, polyethylene naphthalate, polysulfones, polyethersulfones, polyphenylsulfone, polystyrene, polyethylene fluoride, and the like. It may also be a film of any of polyimides, polyamide-imides, polyetherketone, polyarylate, polyvinylchloride, and the like.

In order to provide a multilayer film having a high strength, the resin substrate is preferably a film of at least one resin selected from the group consisting of polyolefins, polyesters, polycarbonates, polyimides, polysulfones, and polyphenylsulfone, and more preferably a film of at least one resin selected from the group consisting of polyolefins and polyesters.

For example, the thickness of the resin substrate is preferably 0.5 to 15.0 μm, more preferably 1.0 to 14.0 μm, and still more preferably 1.2 to 12.0 μm.

If the multilayer film of the present invention is used for onboard film capacitors, the thickness of the resin substrate is preferably 1.5 to 4.0 μm.

If the multilayer film of the present invention is used for industrial film capacitors for the use at high voltages (e.g., 900 V or higher), the thickness of the resin substrate is preferably 4.0 to 12.0 μm.

The resin substrate preferably has a dielectric constant (1 kHz, 30° C.) of 2 to 4, and more preferably 2 to 3.5.

The dielectric constant of the resin substrate is a value calculated on the basis of the capacitance (C) determined using an LCR meter, the electrode area (S), and the thickness (d) of the substrate using the following formula:

C=∈×∈₀×S/d

wherein ∈₀ represents the electric constant under vacuum.

The dielectric layer of the multilayer film of the present invention comprises the copolymer (A) of vinylidene fluoride (VdF) and tetrafluoroethylene (TFE), and the 0.15 copolymer (A) satisfies a mole ratio VdF/TFE of 97 to 60/3 to 40.

Since the dielectric layer comprises the VdF/TFE copolymer (A) having a specific composition, it has a high dielectric constant and leads to a multilayer film that can increase the capacitance.

The VdF/TFE copolymer (A) may further comprise a polymer unit derived from a monomer that is copolymerizable with VdF and TFE.

The VdF/TFE copolymer (A) includes 60 to 100 mol % of the polymer units based on VdF and TFE in 100 mol % of all the polymer units. The amount of the polymer unit derived from a monomer that is copolymerizable with VdF and TFE is preferably 0 to 40 mol % in 100 mol % of all the polymer units. More preferably, the amount in total of the polymer units based on VdF and TFE is 80 to 100 mol % and the amount of the polymer unit based on the monomer copolymerizable with VdF and TFE is 0 to 20 mol % in 100 mol % of all the polymer units.

Examples of the monomer that is copolymerizable with VdF and TFE include fluoroolefins such as tetrafluoroethylene (TFE), chlorotrifluoroethylene (CTFE), trifluoroethylene (TrFE), monofluoroethylene, hexafluoropropylene (HFP), and perfluoro(alkyl vinyl ether) (PAVE); fluoroacrylates; and function-containing fluoromonomers. Preferred are TFE, CTFE, TrFE, and HFP because they are well soluble in a solvent.

The copolymer (A) satisfies a mole ratio VdF/TFE of 97/3 to 60/40. A mole ratio VdF/TFE of 97/3 to 60/40 allows the dielectric layer of the multilayer film of the present invention to have a higher dielectric constant, resulting in an increase in the capacitance. In addition, such a mole ratio leads to a reduction in the dissipation factor. Further, a novel casting technique to be mentioned later can increase the proportion of the β-crystal structure.

A mole ratio VdF/TFE of lower than 60/40 tends to cause a decrease in the dielectric constant of the dielectric layer. A mole ratio VdF/TFE of higher than 97/3 fails to allow the copolymer (A) to have a proportion of the β-crystal structure of 50% or more.

In order to achieve good balance between the dielectric constant and the crystal system, the mole ratio VdF/TFE is more preferably 95/5 to 75/25.

The dielectric layer includes an α-crystal structure and a β-crystal structure, and the proportion of the β-crystal structure is preferably 50% or higher.

The multilayer film of the present invention satisfying a proportion of the β-crystal structure of 50% or more can maintain the high dielectricity, which is a characteristic of a vinylidene fluoride resin, even after long time application of a high voltage, can have a high capacitance, and can have a low dissipation factor. In addition, the multilayer film is excellent in insulation properties.

The proportion of the β-crystal structure is more preferably 70% or more, and still more preferably 80% or more. The β-crystal structure may account for 100%.

The proportion of the β-crystal structure is a value determined from the ratio between the absorbance at the absorption peak (839 cm⁻¹) assigned to the β-crystal and the absorbance at the absorption peak (763 cm⁻¹) assigned to the α-crystal using a Fourier transform infrared (FT-IR) spectrophotometer.

The proportion of the β-crystal structure can be calculated on the basis of the results of the FT-IR determination and the following formula.

F(β)=Xβ/(Xα+Xβ)=Aβ/(1.26Aα+Aβ)

F(β): proportion of β-crystal structure

Xα: crystallinity of α-crystal

Xβ: crystallinity of β-crystal

Aα: absorbance at 763 cm⁻¹

Aβ: absorbance at 839 cm⁻¹

Kβ/Kα=1.26 (ratio between absorption coefficient of β-crystal (839 cm⁻¹) and absorption coefficient of α-crystal (763 cm⁻¹))

The VdF/TFE copolymer (A) preferably has a melting point of 100° C. to 165° C. The melting point is more preferably 110° C. to 160° C., and still more preferably 115° C. to 155° C.

The melting point of the VdF/TFE copolymer (A) is determined as a temperature corresponding to the local maximum on the heat-of-fusion curve obtained at a temperature-increasing rate of 10° C./min using a differential scanning calorimetry (DSC) device.

The dielectric constant (30° C., 1 kHz) of the VdF/TFE copolymer (A) is preferably 5 or higher, more preferably 6 or higher, and still more preferably 7 or higher.

The upper limit of the dielectric constant is not particularly limited, and it is, for example, 12.

The dielectric constant of the VdF/TFE copolymer (A) is a value calculated from the capacitance (C) measured using an LCR meter, the area (S) of the electrode, and the thickness (d) of the film using the following formula:

C=∈×∈₀×S/d

wherein ∈₀ represents the electric constant under vacuum.

In order to achieve a high dielectric constant, the dielectric layer preferably includes the VdF/TFE copolymer (A) alone as the polymer.

The dielectric layer preferably further comprises inorganic oxide particles (B).

The inorganic oxide particles (B) give a high dielectric constant to the multilayer film of the present invention.

Also, the particles (B) can greatly improve the volume resistivity while maintaining the high dielectric constant.

The inorganic oxide particles (B) preferably comprise at least one of the following inorganic oxide particles.

(B1) Inorganic oxide particles of a metal element selected from group 2, group 3, group 4, group 12, or group 13 of the periodic table, or inorganic oxide composite particles thereof.

Examples of the metal element include Be, Mg, Ca, Sr, Ba, Y, Ti, Zr, Zn, and Al. In particular, an oxide of Al, Mg, Y, or Zn is preferred because it can be used for many purposes and is inexpensive, and has a high volume resistivity.

Specifically, particles of at least one selected from the group consisting of Al₂O₃, MgO, ZrO₂, Y₂O₃, BeO, and MgO.Al₂O₃ are preferred because these particles have a high volume resistivity.

In particular, Al₂O₃ whose crystal structure is the γ type is more preferred because it has a large specific surface area and is well dispersible in the VdF/TFE copolymer (A).

(B2) Inorganic oxide composite particles represented by the formula (1):

M¹ₐ₁M²_{b1}O_{c1}

wherein M¹ is a metal element in group 2; M² is a metal element in group 4; a1 is 0.9 to 1.1; b1 is 0.9 to 1.1; c1 is 2.8 to 3.2; and M¹ and M² may each include multiple metal elements.

Preferable examples of the metal element in group 4 include Ti and Zr, and preferable examples of the metal element in group 2 include Mg, Ca, Sr, and Ba.

Specifically, particles of at least one selected from the group consisting of BaTiO₃, SrTiO₃, CaTiO₃, MgTiO₃, BaZrO₃, SrZrO₃, CaZrO₃, and MgZrO₃ are preferred because these particles have a high volume resistivity.

(B3) Inorganic oxide composite particles of silicon oxide and an oxide of a metal element in group 2, group 3, group 4, group 12, or group 13 of the periodic table.

Such particles are composite particles of the inorganic oxide particles (B1) and silicon oxide. Specific examples thereof include particles of at least one selected from the group consisting of 3Al₂O₃.2SiO₂, 2MgO.SiO₂, ZrO₂.SiO₂, and MgO.SiO₂.

The inorganic oxide particles (B) do not necessarily have a high dielectricity, and they may appropriately be selected in accordance with the use of the resulting multilayer film.

For example, use of the oxide particles (B1) of one inexpensive metal which can be used in many uses, in particular Al₂O₃ or MgO, can improve the volume resistivity. The dielectric constant (1 kHz, 25° C.) of the oxide particles (B1) of one metal is typically lower than 100, and further 10 or lower.

In order to improve the dielectric constant, the inorganic oxide particles (B) may be metal oxide particles (e.g., one species of the particles (B2) and (B3)) having ferroelectricity (having a dielectric constant (1 kHz, 25° C.) of 100 or higher).

Examples of the inorganic material constituting the ferroelectric metal oxide particles (B2) and (B3) include, but are not limited to, composite metal oxides, and complexes, solid solutions, and sol-gel materials thereof.

The dielectric layer preferably contains 0.01 to 300 parts by mass of the inorganic oxide particles (B) for 100 parts by mass of the copolymer (A). The amount of the particles (B) is more preferably 0.1 to 250 parts by mass, and still more preferably 1 to 250 parts by mass.

Too much inorganic oxide particles (B) may be difficult to disperse in the copolymer (A) uniformly, and may deteriorate the electric insulation properties (voltage resistance).

The inorganic oxide particles (B) preferably have as small an average primary particle size as possible, and are particularly preferably what is called nanoparticles having an average particle size of 1 μm or smaller. Even a small amount of such inorganic oxide nanoparticles dispersed uniformly can greatly improve the electric insulation properties of the film. The average primary particle size is preferably 300 nm or smaller, more preferably 200 nm or smaller, and particularly preferably 100 nm or smaller. The average particle size may have any lower limit. In order to avoid difficulty in production and uniform dispersion, and to suppress a cost increase, the average primary particle size is preferably 10 nm or greater, more preferably 20 nm or greater, and still more preferably 50 nm or greater.

The average primary particle size of the inorganic oxide particles is a value determined using a laser diffraction scattering particle size distribution analyzer (trade name: LA-920, HORIBA, Ltd.).

The inorganic oxide particles (B) preferably have a dielectric constant (25° C., 1 kHz) of 10 or higher. In order to increase the capacitance of the resulting multilayer film, the dielectric constant of the particles (B) is more preferably 100 or higher, and still more preferably 300 or higher. The upper limit is not particularly limited, and is typically about 3000.

The dielectric constant (c) (25° C., 1 kHz) of the inorganic oxide particles (B) is a value calculated on the basis of the capacitance (C) determined using an LCR meter, the electrode area (S), and the thickness (d) of a sintered body using the following formula:

C=∈x∈₀×S/d

wherein ∈₀ represents the electric constant under vacuum.

### (Other Components)

The dielectric layer may contain other components such as other reinforcing fillers and an affinity improver, if desired.

The reinforcing filler is a component for imparting mechanical properties (e.g., tensile strength, hardness) and comprises particles or fibers different from the aforementioned inorganic oxide particles (B). Examples thereof include particles or fibers of silicon carbide, silicon nitride, and boron compounds. Silica (silicon dioxide) may be added as a processability improver or reinforcing filler. Still, in terms of the effect of improving the insulation properties, silica is poor in thermal conductivity and, in particular, the volume resistivity thereof greatly decreases at high temperatures. Thus, silica is inferior to the inorganic oxide particles (B).

An affinity improver can improve the affinity between the inorganic oxide particles (B) and the copolymer (A), allow the inorganic oxide particles (B) to disperse uniformly in the copolymer (A), bond the inorganic oxide particles (B) and the copolymer (A) firmly in the dielectric layer, suppress generation of voids, and increase the dielectric constant.

The affinity improver may advantageously be a coupling agent, a surfactant, or an epoxy-containing compound.

Examples of the “coupling agent” as an affinity improver include organotitanium compounds, organosilane compounds, organozirconium compounds, organoaluminum compounds, and organophosphorus compounds.

Examples of the organotitanium compounds include coupling agents such as titanium alkoxylates, titanium chelates, and titanium acylates. Preferable examples among these include titanium alkoxylates and titanium chelates because they have good affinity with the inorganic oxide particles (B).

Specific examples thereof include tetraisopropyl titanate, titanium isopropoxy octylene glycolate, diisopropoxy.bis(acetylacetonato)titanium, diisopropoxy titanium diisostearate, tetraisopropyl bis(dioctylphosphite)titanate, isopropyl tri(n-aminoethyl-aminoethyl)titanate, and tetra(2,2-diallyloxymethyl-1-butyl)bis(di-tridecyl)phosphite titanate.

The organosilane compound may be of a high molecular weight type or a low molecular weight type. Examples thereof include alkoxysilanes such as monoalkoxysilanes, dialkoxysilanes, trialkoxysilanes, and tetraalkoxysilanes.

Also, vinylsilane, epoxysilane, aminosilane, methacryloxysilane, mercaptosilane, and the like may suitably be used.

An alkoxysilane can be hydrolyzed to much improve the volume resistivity (improve the electric insulation properties), which is one effect of surface treatment.

Examples of the organozirconium compounds include zirconium alkoxylates and zirconium chelates.

Examples of the organoaluminum compounds include aluminum alkoxylates and aluminum chelates.

Examples of the organophosphorus compounds include phosphorous acid esters, phosphoric acid esters, and phosphoric acid chelates.

The “surfactant” as an affinity improver may be of a high molecular weight type or a low molecular weight type. Examples thereof include nonionic surfactants, anionic surfactants, and cationic surfactants. Preferred are high molecular weight surfactants because they have good heat stability.

Examples of the nonionic surfactants include polyether derivatives, polyvinylpyrrolidone derivatives, and alcohol derivatives. Preferred among these are polyether derivatives because they have good affinity with the inorganic oxide particles (B).

Examples of the anionic surfactants include sulfonic acid and carboxylic acid, and polymers containing a salt thereof. Preferable examples thereof include acrylic acid derivative-based polymers and methacrylic acid derivative-based polymers because they have good affinity with the copolymer (A).

Examples of the cationic surfactant include amine-based compounds and nitrogen-containing heterocyclic compounds such as imidazoline, and halogenated salts thereof.

The “epoxy-containing compound” as an affinity improver may be a low molecular weight compound or a high molecular weight compound. Examples thereof include epoxy compounds and glycidyl compounds. Preferred are low molecular weight compounds having one epoxy group because they have particularly good affinity with the copolymer (A).

Preferable examples of the epoxy-containing compounds include a compound represented by the formula:

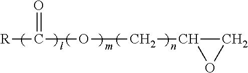

wherein R represents a hydrogen atom, a methyl group, a C2-C10 hydrocarbon group which may optionally include an oxygen atom or a nitrogen atom, or an optionally substituted aromatic ring; 1 is 0 or 1; m is 0 or 1; and n is an integer of 0 to 10. This is because such a compound is particularly excellent in affinity with the copolymer (A).

Specific examples thereof include the compounds represented by the following formulas:

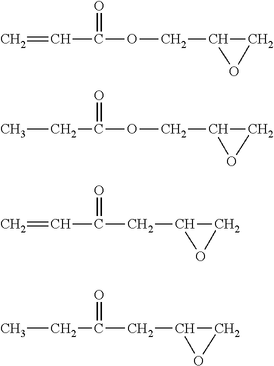

each having a ketone group or an ester group.

The affinity improver can be used in an amount which does not deteriorate the effects of the present invention. Specifically, in order to achieve uniform dispersion of the particles and a high dielectric constant of the dielectric layer, the amount of the affinity improver is preferably 0.01 to 30 parts by mass, more preferably 0.1 to 25 parts by mass, and still more preferably 1 to 20 parts by mass for 100 parts by mass of the inorganic oxide particles (B).

The dielectric layer may further contain other additives in amounts which do not deteriorate the effects of the present invention.

In order to achieve a high capacitance, a low dissipation factor, and an excellent strength together, the dielectric layer preferably occupies 5 to 70% by volume, more preferably 10 to 60% by volume, and still more preferably 20 to 55% by volume, of the multilayer film of the present invention.

In the multilayer film of the present invention, the thickness of the dielectric layer is preferably 0.1 to 12 μm, more preferably 0.1 to 8 μm, and still more preferably 0.1 to 4 μm.

### (Production Method)

The multilayer film of the present invention can be produced by a production method including the steps of: forming a first electrode layer and a second electrode layer on a resin substrate; and forming a dielectric layer on the second electrode layer.

Examples of the method of forming a first electrode layer and a second electrode layer on a resin substrate include a method of attaching a metal foil to a resin substrate; and a method of forming a metal vapor deposition film by vacuum deposition, spattering, ion plating, or the like.

Examples of the method of forming a dielectric layer on the second electrode layer include known film-forming methods such as casting.

Examples of the production method with casting include a method comprising the steps of:

(1) preparing a liquid composition by dissolving or dispersing a copolymer (A) and, if necessary, inorganic oxide particles (B) and an affinity improver in a solvent; and

(2) forming a film by applying the liquid composition to a substrate and drying the composition.

If the proportion of VdF is low and the proportion of TFE is high in the VdF/TFE copolymer, the resulting film naturally has a β-crystal structure. As the proportion of VdF increases, the film is more likely to have an α-crystal structure.

The present inventors have found that a dielectric layer formed by a casting technique in very restricted conditions can have a β-crystal structure at a high proportion even when a VdF/TFE copolymer with a high VdF proportion is used as a material.

Even if the proportion of VdF is high, such like the VdF/TFE copolymer (A) has a mole ratio VdF/TFE of 95/5 to 75/25, the following novel casting technique allows for formation of a dielectric layer in which the VdF/TFE copolymer (A) comprises an α-crystal structure and a β-crystal structure and the proportion of the β-crystal structure is 50% or more.

In the above production method by casting, the solvent may be any one which allows the copolymer (A) to be uniformly dissolved or dispersed therein. In particular, a polar organic solvent is preferred. Preferable examples of the polar organic solvent include ketone solvents, ester solvents, carbonate solvents, cyclic ether solvents, and amide solvents. Preferable specific examples thereof include methyl ethyl ketone, methyl isobutyl ketone (MIBK), acetone, diethyl ketone, dipropyl ketone, ethyl acetate, methyl acetate, propyl acetate, butyl acetate, ethyl lactate, dimethyl carbonate, diethyl carbonate, dipropyl carbonate, methyl ethyl carbonate, tetrahydrofuran, methyl tetrahydrofuran, dioxane, dimethyl formamide (DMF), and dimethyl acetamide.

In the above production method with casting, examples of a method of applying a liquid composition to a substrate include knife coating, cast coating, roll coating, gravure coating, die coating, blade coating, rod coating, and air doctor coating. Preferred is roll coating, gravure coating, die coating, or cast coating because such coating techniques are easy to perform, cause less variations in thickness, and is excellent in productivity.

Such coating techniques can provide a very thin dielectric layer.

In the production method with casting, the drying temperature is preferably around the melting point of the copolymer. This allows for formation of a dielectric layer comprising the copolymer (A) in which the proportion of the β-crystal structure is 50% or more, resulting in production of the multilayer film of the present invention. The drying temperature is more preferably the melting point of the copolymer (A)± about 30° C., and still more preferably a temperature higher than the melting point.

Specifically, the drying temperature is preferably about 150° C.±30° C.

The drying time in the casting production method is preferably 0.75 to 4/3 minutes, and more preferably 1 to 4/3 minutes. The drying temperature within this range can lead to an increase in the proportion of the β-crystal structure in the copolymer (A).

The drying can be achieved by passing the film through a drying furnace. With a drying furnace whose total length is 10 m (e.g., 2 m×5 pieces), for example, the drying can be achieved by passing the film through the drying furnace at a rate of 7.5 to 10 m/min.

The casting production method is preferably performed in a cleanroom, and more preferably in a class 1000 or better (e.g. class 500, class 100, class 10, or class 1) cleanroom in conformity with FED-STD-209D (Federal Specifications and Standards).

The multilayer film of the present invention comprises the dielectric layer having a high dielectric constant, can increase the capacitance, and is excellent in strength. Thus, it can suitably be used as a dielectric film for film capacitors, for example.

The present invention also relates to a film capacitor comprising the multilayer film.

Examples of the structure of a film capacitor include stacked types in which the multilayer films are stacked (e.g., JP S63-181411A) and rolled types in which the multilayer films are rolled up (e.g., those in which electrodes are not entirely stacked on the respective dielectric films (disclosed in JP S60-262414A), those in which electrodes are entirely stacked on the respective dielectric films (disclosed in JP H3-286514A)).

In the case of a simply structured, easy-to-produce rolled-type film capacitor in which electrode layers are entirely stacked on the respective dielectric films, the capacitor is usually produced by rolling up two high dielectric films each of which has an electrode stacked on one side of the film such that the electrodes are not in contact with each other, and then, if necessary, fixing the rolled-up structure so as not to unroll.

### EXAMPLES

The parameters used herein were determined as follows.

### (Thickness)

The thickness of the film was measured using a digital length measuring system (MF-1001, Nikon Corp.).

### (Dissipation Factor and Dielectric Constant)

Aluminum was deposited in vacuo on each surface of the film, thereby preparing a sample. The capacitance and the dissipation factor of this sample were measured using an LCR meter (ZM2353, NF Corp.) at 30° C. and at a frequency of 1 kHz under dry air atmosphere. The dielectric constant was calculated from the film thickness and the capacitance.

### (Volume Resistivity)

The volume resistivity (Ω·cm) was determined using a digital ultra megohmmeter/pico-ammeter at 30° C. and at 300 V DC under dry air atmosphere.

### (Composition of Fluoropolymer)

The fluoropolymer was subjected to a F-NMR measurement using a nuclear magnetic resonance device (type: VNS400 MHz, manufacturer: Varian (the present Agilent Technologies Inc.), providing the spectrum. Based on the integral values of the respective peaks and the following formulas, the compositional ratio was determined.

VdF:A+B−D

TFE:C/2+D

VdF(mol %)=100×{VdF/(VdF+TFE)}

TFE(mol %)=100×{TFE/(VdF+TFE)} Formulas

A: integral value of peak from −90 to −98 ppm

B: integral value of peak from −110 to −118 ppm

C: integral value of peak from −119 to −124.5 ppm

D: integral value of peak from −124.5 to −127 ppm

### (Melting Point)

A heat-of-fusion curve was drawn using a differential scanning calorimetry (DSC) device at a temperature-increasing rate of 10° C./min, and the temperature corresponding to the local maximum of this curve was defined as the melting point.

### (Proportion of β-Crystal Structure)

The proportion of the β-crystal structure was determined as follows. Specifically, the absorbance of the absorption peak (839 cm⁻¹) assigned to the β-crystal and the absorbance of the absorption peak (763 cm⁻¹) assigned to the α-crystal were determined using a Fourier transform infrared (FT-IR) spectrophotometer (trade name: spectrum One, Perkin Elmer Inc.). The ratios of the respective absorbances were defined as the ratios of the respective crystallinities. Then, the proportion of the β-crystal structure was calculated from the following formulas.

More specifically, the proportion is a value calculated on the basis of the results of the FT-IR measurement and the following formulas.

F(β)=Xβ/(Xα+xβ)=Aβ/(1.26Aα+Aβ)

F(β): proportion of β-crystal structure

Xα: crystallinity of α-crystal

Xβ: crystallinity of β-crystal

Aα: absorbance at 763 cm⁻¹

Aβ: absorbance at 839 cm⁻¹

Kβ/Kα=1.26 (ratio between absorption coefficient of β-crystal (839 cm⁻¹) and absorption coefficient of α-crystal (763 cm⁻¹))

### Synthesis Example 1

### Production of VdF/TFE Copolymer (a1)

A 4-L-capacity autoclave was charged with 1.3 kg of pure water, and sufficiently purged with nitrogen. Then, 1.3 g of octafluorocyclobutane was put thereinto, and the inside of the system was maintained at a temperature of 37° C. and at a stirring rate of 580 rpm. Thereafter, 200 g of a gas mixture of tetrafluoroethylene (TFE)/1,1-difluoroethylene (vinylidene fluoride, VdF) (=0.7/93 mol %) and 1 g of ethyl acetate were put into the autoclave. Further, 1 g of a 50% by mass solution of di-n-propyl peroxydicarbonate in methanol was added thereto, initiating the polymerization. Since the pressure in the system decreased in response to the progress of the polymerization, a gas mixture of tetrafluoroethylene/1,1-difluoroethylene (=7/93 mol %) was continually supplied to the reaction system so as to maintain the pressure in the system at 1.3 MPaG. The stirring was continued for 20 hours. The pressure was then released to atmospheric pressure, and the reaction product was washed with water and dried, thereby providing 130 g of white powder of fluoropolymer.

### Synthesis Example 2

### Production of VdF/TFE Copolymer (a2)

A 4-L-capacity autoclave was charged with 1.3 kg of pure water, and sufficiently purged with nitrogen. Then, 1.3 g of octafluorocyclobutane was put thereinto, and the inside of the system was maintained at a temperature of 37° C. and at a stirring rate of 580 rpm. Thereafter, 200 g of a gas mixture of TFE/VdF (=35/65 mol %) and 1 g of ethyl acetate were put into the autoclave. Further, 1 g of a 50% by mass solution of di-n-propyl peroxydicarbonate in methanol was added thereto, initiating the polymerization. Since the pressure in the system decreased in response to the progress of the polymerization, a gas mixture of tetrafluoroethylene/1,1-difluoroethylene (=35/65 mol %) was continually supplied to the reaction system so as to maintain the pressure in the system at 1.3 MPaG. The stirring was continued for 20 hours. The pressure was then released to atmospheric pressure, and the reaction product was washed with water and dried, thereby providing 125 g of white powder of fluoropolymer.

### Synthesis Example 3

### Production of VdF/TFE Copolymer (a3)

A 4-L-capacity autoclave was charged with 1.3 kg of pure water, and sufficiently purged with nitrogen. Then, 1.3 g of octafluorocyclobutane was put thereinto, and the inside of the system was maintained at a temperature of 37° C. and at a stirring rate of 580 rpm. Thereafter, 200 g of a gas mixture of TFE/VdF (=20/80 mol %) and 1 g of ethyl acetate were put into the autoclave. Further, 1 g of a 50% by mass solution of di-n-propyl peroxydicarbonate in methanol was added thereto, initiating the polymerization. Since the pressure in the system decreased in response to the progress of the polymerization, a gas mixture of tetrafluoroethylene/1,1-difluoroethylene (=20/80 mol %) was continually supplied to the reaction system so as to maintain the pressure in the system at 1.3 MPaG. The stirring was continued for 20 hours. The pressure was then released to atmospheric pressure, and the reaction product was washed with water and dried, thereby providing 130 g of white powder of fluoropolymer.

### Example 1

A 2-L tank was charged with 560 parts by mass of methyl ethyl ketone (MEK) (KISHIDA CHEMICAL Co., Ltd.), 240 parts by mass of N-methyl-2-pyrrolidone (NMP) (NIPPON REFINE Co., Ltd.), and 200 parts by mass of the VdF/TFE copolymer (a1) (VdF/TFE=93/7 mol %, melting point=150° C.) produced in Synthesis Example 1. The components were stirred with a stirrer, thereby providing a 20 w/w % fluororesin solution.

This fluororesin solution was cast on a 3-μm-thick double-sided metallized polypropylene (PP) film using a gravure coater in a class 1000 cleanroom. The workpiece was dried through drying furnaces (2 m each, 10 m in total) at 80° C., 120° C., 175° C., 175° C., and 175° C. at a rate of 7.5 m/min for 1.3 minutes, thereby providing a laminate film including the metallized PP film and a fluororesin layer formed on the PP film. The thickness of the multilayer film was 4.5 μm.

Owing to the formation of the film under the above drying conditions, a fluororesin layer (VdF/TFE copolymer layer) was produced in which the proportion of the β-crystal structure was 100% and the ratio between VdF/TFE=93/7 mol %.

### Example 2

In the same manner as in Example 1, a 20 w/w % fluororesin solution was prepared and this solution was cast on a PP film, thereby providing a 6.1-μm-thick multilayer film.

For the resulting fluororesin layer, the proportion of the β-crystal structure was 100%.

### Example 3

In the same manner as in Example 1, a 20 w/w % fluororesin solution was prepared. To 1000 parts by mass of this fluororesin solution was added 10 parts by mass of γ-Al₂O₃ (trade name: AKP-G15, Sumitomo Chemical Co., Ltd., average primary particle size: 100 nm). This mixture was subjected to a dispersion treatment using a bead mill (LMZ015, Ashizawa Finetech Ltd.) at a rotation rate of 12 m/s for 60 minutes, thereby providing a solution for coating. This solution was cast on a PP film in the same manner as in Example 1, thereby providing a 4.5-μm-thick multilayer film.

For the resulting fluororesin layer, the proportion of the β-crystal structure was 100%.

### Example 4

In the same manner as in Example 1, a 20 w/w % fluororesin solution was prepared. To 1000 parts by mass of this fluororesin solution was added 20 parts by mass of BaTiO₃ (trade name: BT-01, 100 nm). This mixture was subjected to dispersion treatment using a bead mill (LMZ015, Ashizawa Finetech Ltd.) at a rotation rate of 12 m/s for 60 minutes, thereby providing a solution for coating. This solution was cast on a PP film in the same manner as in Example 1, thereby providing a 4.7-μm-thick multilayer film.

For the resulting fluororesin layer, the proportion of the β-crystal structure was 100%.

### Example 5

A 4.7-μm-thick multilayer film was produced in the same manner as in Example 1 except that the resin substrate was a 2.3-μm-thick polypropylene film.

For the resulting fluororesin layer, the proportion of the β-crystal structure was 100%.

### Example 6

A 17.5-μm-thick multilayer film was produced in the same manner as in Example 1 except that the resin substrate was a 15-μm-thick polypropylene film.

For the resulting fluororesin layer, the proportion of the β-crystal structure was 100%.

### Example 7

A 6.9-μm-thick multilayer film was produced in the same manner as in Example 1 except that the resin substrate was a 4.8-μm-thick polyester (PET) film.

For the resulting fluororesin layer, the proportion of the β-crystal structure was 100%.

### Example 8

A 9.0-μm-thick multilayer film was produced in the same manner as in Example 1 except that the resin substrate was a 7.5-μm-thick polyimide (PI) film.

For the resulting fluororesin layer, the proportion of the β-crystal structure was 100%.

### Example 9

A 20 w/w % fluororesin solution was prepared and this solution was cast on a PP film, thereby providing a 4.5-μm-thick multilayer film in the same manner as in Example 1 except that the VdF/TFE copolymer was replaced by the VdF/TFE copolymer (a2) (VdF/TFE=65/35 mol %, melting point: 170° C.) produced in Synthesis Example 2.

For the resulting fluororesin layer, the proportion of the β-crystal structure was 100%.

### Example 10

A 20 w/w % fluororesin solution was prepared and this solution was cast on a PP film, thereby providing a 4.5-μm-thick multilayer film in the same manner as in Example 1 except that the VdF/TFE copolymer was replaced by the VdF/TFE copolymer (a3) (VdF/TFE=80/20 mol %, melting point: 130° C.) produced in Synthesis Example 3.

For the resulting fluororesin layer, the proportion of the β-crystal structure was 100%.

### Example 11

A 20 w/w % fluororesin solution was prepared and this solution was cast on a PP film, thereby providing a 12.0-μm-thick multilayer film in the same manner as in Example 1.

For the resulting fluororesin layer, the proportion of the β-crystal structure was 100%.

For the films produced in Examples 1 to 11, the data on capacitance, dielectric constant, dissipation factor, and volume resistivity were obtained. Table 1, Table 2, and Table 3 show the results.

TABLE 1

| | Example 1 | Example 2 | Example 3 | Example 4 | Example 5 | Example 6 |
|---|---|---|---|---|---|---|
| Thickness (μm) | | | | | | |
| PP layer | 3.0 | 3.0 | 3.0 | 3.0 | 2.3 | 15.0 |
| VdF/TFE copolymer layer (VdF/TFE = 93/7 mol %) | 1.5 | 3.1 | — | — | 2.4 | 2.5 |
| VdF/TFE copolymer layer (containing γ-Al₂O₃) | — | — | 1.5 | — | — | — |
| VdF/TFE copolymer layer (containing BaTiO₃) | — | — | — | 1.7 | — | — |
| Ratio by volume of VdF/TFE copolymer layer (vol %) | 33.3 | 50.8 | 33.3 | 36.2 | 51.1 | 14.3 |
| Capacitance (1 kHz) nF | | | | | | |
| PP layer | 2.0 | 2.0 | 2.0 | 2.0 | 2.6 | 0.4 |
| VdF/TFE copolymer layer | 19.1 | 9.2 | 18.7 | 18.0 | 11.9 | 11.5 |
| Dielectric constant (1 kHz) | | | | | | |
| PP layer | 2.2 | 2.2 | 2.2 | 2.2 | 2.2 | 2.2 |
| VdF/TFE copolymer layer | 10.7 | 10.6 | 10.5 | 11.4 | 10.7 | 10.7 |
| Dissipation factor (1 kHz) % | | | | | | |
| PP layer | 0.02 | 0.02 | 0.02 | 0.02 | 0.02 | 0.02 |
| VdF/TFE copolymer layer | 1.54 | 1.46 | 1.61 | 2.10 | 1.53 | 1.53 |
| Volume resistivity (Ω · cm) | | | | | | |
| PP layer | >1 × 10¹⁶ | >1 × 10¹⁶ | >1 × 10¹⁶ | >1 × 10¹⁶ | >1 × 10¹⁶ | >1 × 10¹⁶ |
| VdF/TFE copolymer layer | 1 × 10¹⁵ | 1 × 10¹⁵ | 7 × 10¹⁵ | 3 × 10¹⁵ | 1 × 10¹⁵ | 1 × 10¹⁵ |

TABLE 2

| | Example 7 | Example 8 |
|---|---|---|
| Thickness (μm) | | |
| PET layer | 4.8 | — |
| PI layer | — | 7.5 |
| VdF/TFE copolymer layer (VdF/TFE = | 2.1 | 1.5 |
| 93/7 mol %) | | |
| Ratio by volume of VdF/TFE copolymer | 30.4 | 16.7 |
| layer (vol %) | | |
| Capacitance (1 kHz) nF | | |
| PET layer | 1.8 | — |
| PI layer | — | 1.2 |
| VdF/TFE copolymer layer | 13.6 | 18.9 |
| Dielectric constant (1 kHz) | | |
| PET layer | 3.2 | — |
| PI layer | — | 3.3 |
| VdF/TFE copolymer layer | 10.7 | 10.6 |
| Dissipation factor (1 kHz) % | | |
| PET layer | 0.30 | — |
| PI layer | — | 0.28 |
| VdF/TFE copolymer layer | 1.54 | 1.55 |
| Volume resistivity (Ω · cm) | | |
| PET layer | >1 × 10¹⁷ | — |
| PI layer | — | >1 × 10¹⁷ |
| VdF/TFE copolymer layer | 1 × 10¹⁵ | 1 × 10¹⁵ |

TABLE 3

| | Example 9 | Example 10 | Example 11 |
|---|---|---|---|
| Thickness (μm) | | | |
| PP layer | 3.0 | 3.0 | 3.0 |
| VdF/TFE copolymer layer | — | — | 9.0 |
| (VdF/TFE = 93/7 mol %) | | | |
| VdF/TFE copolymer layer | 1.5 | — | — |
| (VdF/TFE = 65/35 mol %) | | | |
| VdF/TFE copolymer layer | — | 1.5 | — |
| (VdF/TFE = 80/20 mol %) | | | |
| Ratio by volume of VdF/TFE | 33.3 | 33.3 | 75.0 |
| copolymer layer (vol %) | | | |
| Capacitance (1 kHz) nF | | | |
| PP layer | 2.0 | 2.0 | 2.0 |
| VdF/TFE copolymer layer | 17.9 | 17.0 | 3.2 |
| Dielectric constant (1 kHz) | | | |
| PP layer | 2.2 | 2.2 | 2.2 |
| VdF/TFE copolymer layer | 10.0 | 9.5 | 10.7 |
| Dissipation factor (1 kHz) % | | | |
| PP layer | 0.02 | 0.02 | 0.02 |
| VdF/TFE copolymer layer | 1.51 | 1.39 | 1.54 |
| Volume resistivity (Ω · cm) | | | |
| PP layer | >1 × 10¹⁶ | >1 × 10¹⁶ | >1 × 10¹⁶ |
| VdF/TFE copolymer layer | 1 × 10¹⁵ | 1 × 10¹⁵ | 1 × 10¹⁵ |

### INDUSTRIAL APPLICABILITY

Since the multilayer film of the present invention can increase the capacitance, it is suitable as a dielectric film for film capacitors.

### REFERENCE SIGNS LIST

10, 20: dielectric layer
11, 21: second electrode layer
12, 22: resin substrate
13, 23: first electrode layer

1. A multilayer film comprising
a first electrode layer, a resin substrate, a second electrode layer, and a dielectric layer stacked in the order set forth,
the dielectric layer comprising a vinylidene fluoride/tetrafluoroethylene copolymer (A), and
the copolymer (A) satisfying a mole ratio (vinylidene fluoride)/(tetrafluoroethylene) of 97/3 to 60/40.

2. The multilayer film according to claim 1,
wherein the copolymer (A) satisfies a mole ratio (vinylidene fluoride)/(tetrafluoroethylene) of 95/5 to 75/25.

3. The multilayer film according to claim 1,
wherein the dielectric layer has a thickness of 0.1 to 12 μm.

4. The multilayer film according to claim 1,
wherein the resin substrate is a film of at least one resin selected from the group consisting of polyolefins, polyesters, polycarbonates, polyimides, polysulfones, and polyphenylsulfone.

5. The multilayer film according to claim 1,
wherein the resin substrate has a thickness of 0.5 to 15.0 μm.

6. A film capacitor comprising
the multilayer film of claim 1.
